(19) United States
(12) Patent Application Publication
(10) Pub. No.: US 2013/0234630 A1
(43) Pub. Date: Sep. 12, 2013

(54) PROGRAMMABLE MOTOR AND METHOD

(71) Applicant: Peiqi Yang, Auckland (NZ)

(72) Inventor: Peiqi Yang, Auckland (NZ)

(73) Assignee: WELLINGTION DRIVE TECHNOLOGIES LIMITED, Auckland (NZ)

(21) Appl. No.: 13/884,437

(22) PCT Filed: Oct. 28, 2011
(86) PCT No.: PCT/NZ2011/000229

§ 371 Date: May 9, 2013

(30) Foreign Application Priority Data
Nov. 10, 2010 (NZ) 589148

(51) Int. Cl. H02P 23/00

(52) U.S. Cl. CPC H02P 23/00
USPC 318/244

(57) ABSTRACT

An electronically commutated motor is programmed by applying a low frequency mains supply (303) to trigger the motor into programming mode (304) and then applying configuration data (306) to the motor by yet further frequency variations. An indication of the success or otherwise of the programming operation may be made by specific rotation of the motor rotor at the end of the programming (314).

### TECHNICAL FIELD OF THE INVENTION

The invention generally relates to motors which are programmable as to their operating characteristics.

More particularly the invention relates to motors which may be programmed as to direction of rotation, speed, acceleration and other operating characteristics or settings.

### BACKGROUND OF THE INVENTION

Electronically commutated motors (ECMs) are commonly used as replacements for single phase induction motors in refrigeration systems and other appliances, in order to improve efficiency. A variety of induction motors are typically used in such systems, which may have different speeds, directions, or other operating parameters. For best performance of the system, it is desirable that the ECM match the parameters of the motor being replaced.

In order to minimise the number of ECM models held by the installer or system manufacturer, it is therefore desirable to be able to set the operating parameters of an otherwise standard ECM at the time of installation. Since frequently several motors must be set to the same parameters, particularly in large installations or on a production line, it is also desirable that the parameter setting be achievable on multiple motors simultaneously.

Several methods are known for making such settings.

One method is to provide jumpers or jumper cables on each motor which can be permanently connected or disconnected on installation to give different behaviours—for example an ECM may be configured to rotate clockwise if a particular jumper is connected and counter-clockwise if disconnected. This system has the disadvantage that additional cabling and other hardware is required in the motor, and that the range of adjustments available is small unless the number of jumpers is large.

Another method is to provide externally accessible switches such as DIP switches which achieve the same function. This allows a larger number of practical adjustments, but adds cost and bulk, and compromises reliability—particularly if the switches must be sealed against harsh environments.

An alternative method is to provide an externally accessible programming port which allows the control microprocessor to be reprogrammed to provide the desired performance. This offers a wide range of adjustment options, but suffers from the same complexity and protection issues as DIP switches since the programming connection must be protected. Where multiple motors are to be programmed simultaneously, a sophisticated communications protocol is required to address each separate motor, potentially requiring a more complex microprocessor in the motor.

Also present in the art is U.S. Pat. No. 7,054,696 which receives a different mains frequency, from a monitoring apparatus and downloads data by varying the speed control electronics, and U.S. Pat. No. 6,668,571 which relates to a refrigeration controller using temperature and load stimuli to vary the supply frequency to the refrigeration compressor motor. Neither of these relate to programming settings or configuration of a motor.

There is therefore a need for a method of setting a wide range of ECM parameters at the time of installation, which does not require additional hardware or external connections and which ideally is useable on multiple motors simultaneously.

### SUMMARY OF THE INVENTION

In one aspect the invention relates to a programmable alternating current supplied motor, the motor having;
a programmer capable of programming motor characteristics
a sensor sensing the frequency of the applied alternating current
a first detector mode activated when the applied alternating current frequency is within a range of frequencies outside those of normal supply frequencies,
a switch switching the motor into programming mode in response to the activation of the detector,
a second detector mode activated by switching the motor into programming mode and detecting changes in the alternating current supply frequency as programming data.

Preferably the first detector mode is activated by a frequency substantially below the normal supply frequency.

Preferably the first detector mode is activated by a frequency of substantially 36 Hz.

Preferably the second detector mode is activated by variations in frequency substantially above the normal supply frequencies.

Preferably the second detector is activated by frequencies varying between 160 Hz and 210 Hz centred around 190 Hz.

In a further aspect the invention consists in a motor programming power supply having an input power receiver for a fixed frequency power supply, a power converter converting the power from the power receiver to a controllable output frequency at a power output, a frequency controller controlling the output frequency of the power converter, the frequency controller controlled by configuration data to provide a varying frequency at the power output corresponding to the configuration data.

Preferably the configuration data may be varied remote from the motor programming power supply.

Preferably the output from the motor programming power supply supplies more than one motor simultaneously.

The invention also encompasses a method of supplying a power output to an electronically commutated motor having a controllably variable output frequency, by providing a controllable frequency power supply, the power supply frequency being controllable to a first frequency distinguishably different from the designed motor supply frequency and at least a second frequency substantially different from the first frequency, the relative periods for which the first frequency and at least the second frequency are output providing at the power output of the power supply a controllable frequency power output carrying programming data.

In another aspect the invention provides a method of programming an AC supplied electronically commutated motor having a programmable motor controller by detecting the frequency of the supplied motor power, detecting when the frequency of the supplied motor power indicates the initialization of a programming sequence in the supplied motor power, switching the motor controller into a programming mode on detection of that frequency, receiving subsequent variations in frequency of the supplied motor power as motor controller programming instructions, and programming the instructions to the motor controller on successful receipt of the programming sequence.

Preferably the frequency indicating initialization is substantially below the design operating frequency of the motor.

Preferably the subsequent variations in frequency are substantially above the design operating frequency of the motor.

Preferably the subsequent variations in frequency vary between two frequencies.

Preferably the subsequent variations in frequency vary between three frequencies.

Preferably when the programming is successfully received by the programmable motor controller the controller initiates a specific rotor movement.

### BRIEF DESCRIPTION OF THE DRAWINGS

FIG. 1 is a diagram of the connection of a motor for programming.

FIG. 2 is a waveform diagram of a typical programming waveform plot.

FIG. 3 is a flow diagram of a typical motor controller programming routine.

FIG. 4 is a top perspective view of a typical motor of the invention.

FIG. 5 is a bottom perspective view of the same motor.

FIG. 6 is a bottom perspective view with the cover removed to show the programmable electronics.

### DESCRIPTION

FIG. 1 shows a computer 101 which transmits programming information via a USB connection to an interface module 102 which is a motor programming power supply. The interface module is powered by a mains AC supply 103 and supplies to an AC electronically commutated motor 104 with a programmable motor controller an AC supply of varying output frequency which variations carry the programming information or the settings or configuration for the program. In response to the information, and in particular the success or otherwise of any programming, the motor may rotate or oscillate in directions 105.

One method of general operation to program motor settings is to transmit these by serial data communication such as USB to an interface module 102 forming part of a mains supply module, and thence to the motor 104 over the mains wire using a variation on frequency shift keying in which the frequency of the applied alternating current is varied as a whole.

Communication to the motor controller in motor 104 is preferably unidirectional, since this reduces the resources required at the controller, with feedback on success or failure of the data transmission and reprogramming being given directly to the user by visual or audible means through actuation of the motor 104: for instance the motor may be programmed to shake to indicate a successful programming and rotate to indicate a failure.

The interface module may itself be merely be a programmable variant of a typical motor controller offering AC-DC-AC conversion in which the fixed frequency input AC voltage is received in a power receiver, converted to DC and electronically commutated under program control to provide a power converter offering at a power output the required output power at controllable output frequencies. The methods used to provide the commutation are those normally used to control the commutation of an electronically commutated DC motor from an AC supply with the difference that the waveform provided is of specified frequency and preferably of equal positive and negative periods. It is not necessary that the output is a pure sine wave since the output waveform need be only something which the receiving ECM controllers will accept as a motor programming power supply. In most cases a square wave is acceptable.

The interface module may be directly controlled as to frequency by the connected computer, or the required programming sequence may be loaded into the interface module and invoked by a button press. This latter method is preferable where many motors must be programmed.

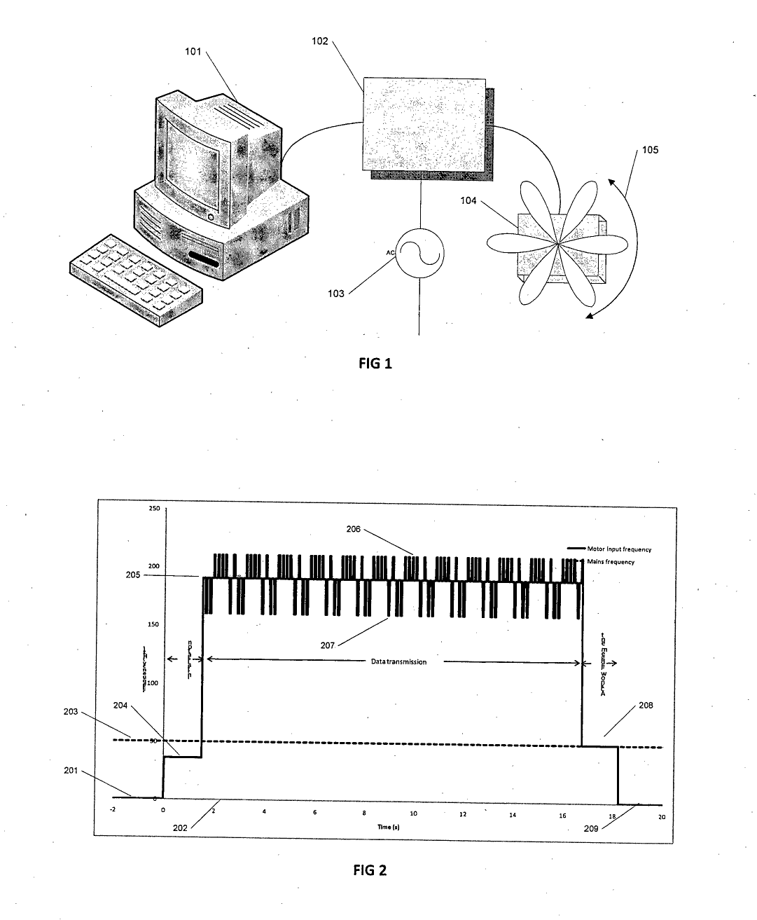

FIG. 2 shows one possible programming session with a motor in terms of the supplied mains frequency versus time with a zero supply frequency at 201 on timeline 202. The standard mains frequency is shown by the dotted line at 203.

At the commencement of the programming an initialising AC voltage at a lower frequency 204 is supplied to an alternating current motor as the motor power. This supply frequency may be substantially below the standard frequency at 36 Hz and the motor controller, which has zero crossing recognition as part of the control system, has a first detector mode which recognizes the increased time compared to the standard mains frequency between zero crossings and is activated to switch to a programmable mode. After a time which is long enough for the motor to have recognized the initializing frequency the programming data starts at a base frequency 205 of 190 Hz with a frequency shift between 210 Hz for a digital “1” 206 and 160 Hz for a digital “0” 207. The received data is recognized in a second detector mode by the motor controller and read into the appropriate ones of the memories on board the controller typically as configuration data or settings. The initialising frequency and the programming data frequencies are both outside the normal range of power frequencies, which is typically 50 Hz or 60 Hz plus or minus 5%.

At the end of the data sequence the frequency drops to the standard mains frequency 208 to indicate that the programming sequence is complete. During this period the motor controller may respond to the programming by indicating whether or not it was validly applied to the controller. This may be by oscillating the motor rotor on or off or by rotating at a constant rate or some other detectable variation.

The frequency supplied to the motor may be substantially below the designed operating frequency of the motor as inefficiencies produced by this do not matter since the motor is not under load.

The interface module contains an AC-DC-AC converter which is capable of converting the fixed frequency AC mains in to a single phase output of arbitrary frequency at mains voltage or less: an unmodified or lightly modified ECM controller (albeit with custom software acting as a frequency controller) is suitable for this purpose. The output waveform need not be sinusoidal—a square wave or other shape with clearly defined zero crossings is acceptable and is simpler to synthesise. The converter must be capable of supplying enough current to satisfy inrush and motor-starting current draws of as many motors are as to be programmed simultaneously. The AC-DC-AC converter contains, or is connected to, an isolated communications interface for communicating with the PC. Where multiple motor connection points are provided, these are connected in parallel.

The motor must have a controller with hardware which is capable of detecting zero crossings on the mains input, and embedded software which allows decoding of data encoded in variations in the timing of these crossings, and reprogramming of non-volatile memory based on this data. The hardware aspects of these requirements are commonly present in ECM controllers, so no additional hardware is normally required, merely a minimal software programming interface.

At the start of the process, the output from the interface module to the motor is switched off. To initialise the process, the interface module switches on the output at mains voltage but at a grossly non-mains frequency (in the current implementation 36 Hz). A lower-than-mains frequency which is not a sub-harmonic of mains frequency may be selected, to minimise the chance of high-frequency noise or missed zero crossings accidentally initialising this mode in service.

This frequency is output for long enough to allow the motor controller to power up, self test, and detect enough zero crossings to get a good estimate of input frequency even in the presence of noise (typically 1.5 seconds is adequate).

After the initialisation period the interface module shifts the output waveform to a carrier frequency—in the current implementation 190 Hz. A higher-than-mains frequency is selected to increase baud rate: this is possible because, unlike the initialisation step, the effects of false interpretation are not disastrous, merely inconvenient in that the programming will have no effect.

Data is transmitted by shifting this frequency for a fixed number of cycles, typically by allowing the frequency to vary between fixed frequencies. In the current implementation a “1” is represented by a shift to a first frequency of 210 Hz for 10 cycles, and a “0” is represented by a shift to a second frequency of 160 Hz for 10 cycles. Each bit is separated by 10 cycles at the carrier frequency, giving a baud rate of 30 cycles, or on average 6.3 bits/sec.

Data is transmitted in fixed-length blocks (in the current implementation 3 bytes), each block followed by a CRC check.

Once all data has been transmitted—regardless of success or otherwise, which is unknown to the interface module—the interface module shifts the output frequency to the same frequency as the incoming mains—50 or 60 Hz. This is output for a period (1.5 seconds in the current implementation), after which the output is turned off, powering the motor down.

As a result of being supplied with the programming sequence from the interface module:

When the motor detects the initialisation frequency (in the implementation shown by observing 16 sequential zero crossings at the expected frequency, which is enough to ensure against accidental detection) it enters programming mode. If the reduced frequency is not detected, the motor will follow its normal power-up behaviour, which is to start rotating. This provides a visual/audible indicator that programming has been unsuccessful and must be restarted.

During receipt of the programming information, for correct reception of each bit, the motor must detect 4 sequential zero crossings at the correct frequency followed (not necessarily immediately) by 4 at the carrier frequency. Such a sequence of correctly detected bits together with a trailing CRC bit makes up the fixed-length block. This ternary code provides greater immunity to interference.

If a block is successfully received, the motor awaits either the next block or an “acknowledge” command as described below. If a block is not successfully received—either due to timeout or a bad CRC check—the motor resets itself and repeats the power-up behaviour above. Since the initialisation frequency will not be detected at this stage in the process, the net effect of a data transmission failure is to cause the motor to revert to its normal operating state.

When normal mains frequency is detected, the motor reacts in one of three ways:
If the motor is in programming mode and all expected data has been successfully received (i.e. if all steps above have been successfully completed), the motor programs the new settings into its non-volatile memory. It then briefly energises its windings in such away as to give a distinctive noise and oscillating motion, providing a visual/audible indicator of success. Finally, it enters an idle state which can only be exited from by powering down and turning back on.
If the motor is in programming mode, and all expected data has not been received—for example if 4 data packets were expected and only 3 have been seen—the motor resets itself. As this takes only a fraction of a second, it then moves on to the next state below.
If the motor is not in programming mode, either because it never entered it or because of a reset caused by one of the errors above, it executes normal start-up behaviour, and begins to rotate until the interface module turns off power. A rotating motor is therefore a visual indicator of failure to reprogram.

Because the interface module does not rely on receiving bidirectional data from any attached motor it is capable of programming as many motors as it can supply. The success of the programming of each motor can be detected visually by an observer, or may equally be detected optically by an observing photo-optical detector or audibly by an observer or microphone.

The motor itself consists typically of a DC motor together with an integrated motor controller; the motor controller is powered from the rectified applied AC supply and includes the usual microprocessor with minimal flash RAM which can store required operating parameters. The microprocessor drives a controlled converter to drive the ECM from the rectified AC supply. Since the aim is to provide the same speeds under load as an induction motor, the characteristics of the converter are normally set by the microprocessor RAM so that the motor approaches the induction motor synchronous speed at full load. The motor therefore requires a measurement of the frequency of the input AC supply, which is derived from the time between zero crossings of the AC supply waveform.

To allow programming of the motor requires only a change in the microprocessor programming to allow recognition of the programming frequencies from the zero crossing times and subsequent alteration of the configuration data.

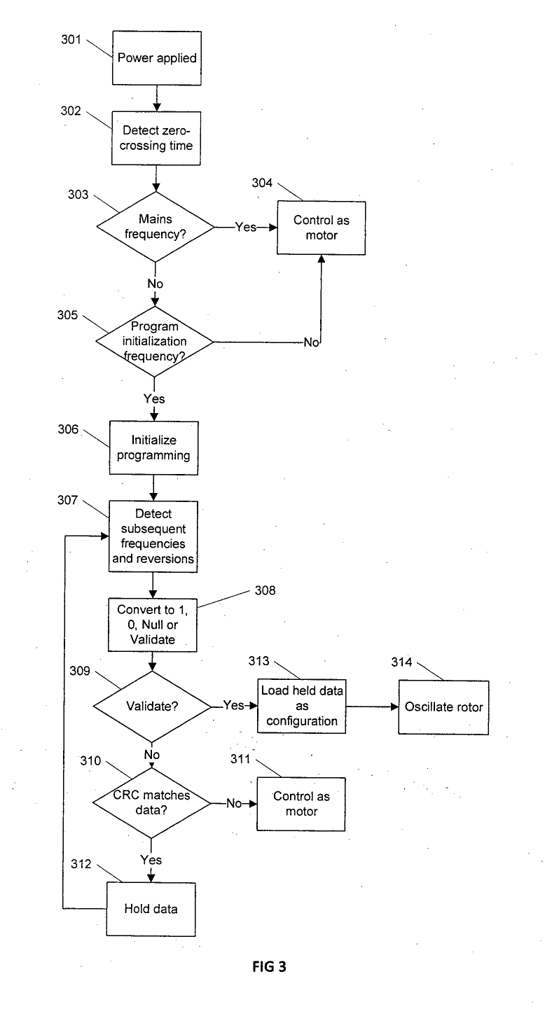

FIG. 3 shows a flow chart for the receipt of the programming sequence at the motor controller in which when power is applied at 301 the motor controller detects the time between zero crossings at 302 and at 303 determines whether this is the standard mains frequency power. If so the sequence diverts to 304 where the motor is controlled in accordance with whatever its current configuration is.

If the applied power is not at mains frequency a check is made at 305 for a program sequence initialization frequency. If this not found the motor reverts to the currently configured control pattern.

Where the required initialization frequency is found programming is initialized at 306 and any subsequent frequency changes or reversions are detected at 307 and converted to digital “1”s, “0”s, Nulls (not a known frequency) or indications that validation of the programming sequence should be made at 308.

A check for a validation requirement is made at 309 and if none is required and the bit is a CRC bit it is checked at 310 for the correct value. If the value is wrong the motor reverts at 311 to the current motor controller configuration.

When the bit is valid it is stored at 312 and the next frequency change detected. When the frequency for a validity check is received the input data which is held is written as the new configuration at 313, the rotor is oscillated (or some other indication made) at 314.

The initializing frequency may be any frequency sufficiently differenced from the standard mains frequency that the normal zero-crossing detector on a motor controller can reliably detect the difference, and it should not be any frequency at which harmonics or sub-harmonics of the standard mains frequency occur. The initialising frequency may itself be a sequence of two or more different frequencies, though in most cases this is not warranted.

The data frequencies as described above provide a form of frequency shift keying, but any form of modulation which can be reliably detected by the zero-crossing detector in the motor controller may be used, and other forms may be used if a more complex controller is available. The actual data frequencies may be any frequency reliably detectable by the controller zero-crossing detector, including the standard mains frequency, and the code sequence may be binary or ternary.

The use of the standard mains frequency as one of the frequencies is possible, but for quicker programming a higher frequency is more convenient as providing a greater baud rate and faster programming.

It is theoretically possible to program an ECM motor using different applied voltages for the data bits, but the standard controller is not particularly adapted to detect finer voltage levels which would be necessary.

While a uni-directional communication system is described a bi-directional communication system is equally possible by detecting at the interface module the current drawn by the motor. Such a system could not work with multiple motors supplied from a single interface module, and in these circumstances a full bi-directional system for each individual motor raises the complexity and reduces the possible baud rate.

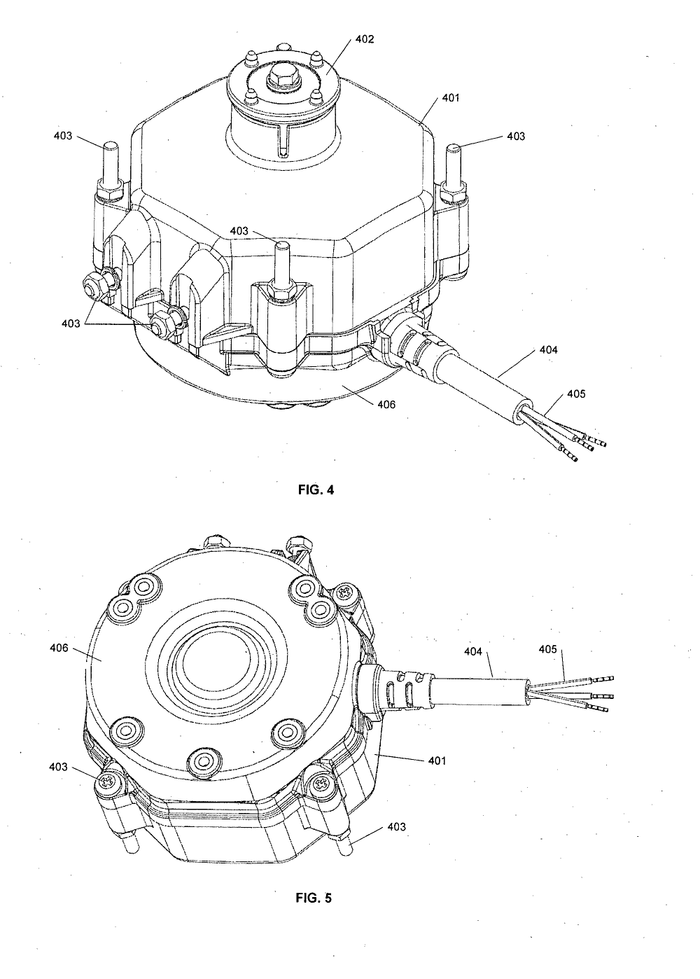

FIGS. 4 and 5 show top and bottom perspective views respectively of a motor typical of the type needing programming. A motor casing 401 contains the stator and rotor with a shaft mounting boss 402 to which a fan may be fixed. The motor may be mounted by hardware 403 which may also secure the casing 401 to the base cover 406. A power cord with wires 405 may carry power at either mains frequency or programming frequencies into the motor.

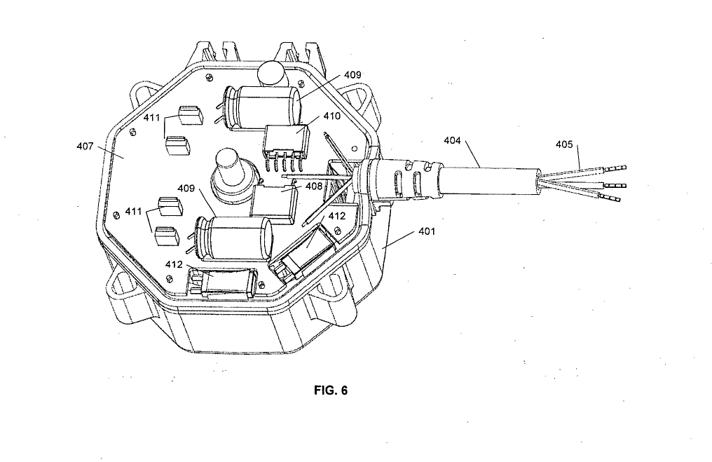

FIG. 6 shows the same motor without the base cover. The printed circuit board 407 onto which most of the electronic components are mounted is shown together with mains rectifier 408, capacitors 409 and microprocessor 410 forming the heart of the motor controller. The microprocessor provides the waveforms to commutate the motor to drive transistor pairs 411 which supply the stator coils (not visible). Thermostats 412 located in the stator coil surrounds allow detection of over temperature and safe shutdown of the motor if necessary. As described above the microprocessor monitors the zero crossing of the supply on wires 405 and switches modes to a programming mode if the correct frequency is received. When correctly programmed the microprocessor 410 provides the required action from the motor so that, for instance, the boss 402 shakes back and forth.

The voltage provided to the motors for programming does not necessarily need to be the full rated voltage, provided that the voltage is sufficient to power the motor controller and preferably provide some indication when programming does not succeed.

### Variations

It is to be understood that even though numerous characteristics and advantages of the various embodiments of the present invention have been set forth in the foregoing description, together with details of the structure and functioning of various embodiments of the invention, this disclosure is illustrative only, and changes may be made in detail so long as the functioning of the invention is not adversely affected. For example the particular elements of the interface module may vary dependent on the particular application for which it is used without variation in the spirit and scope of the present invention.

In addition, although the preferred embodiments described herein are directed to electronically controlled motors for use in a programmable motor system, it will be appreciated by those skilled in the art that variations and modifications are possible within the scope of the appended claims.

### INDUSTRIAL APPLICABILITY

The motor programmer of the invention is used in the programming of motors which are employed in many industries, such as the fan motor industry. The present invention is therefore industrially applicable.

1. A programmable alternating current supplied motor, the motor having;
a programmer capable of programming motor characteristics
a sensor sensing the frequency of the applied alternating current
a first detector mode activated when the applied alternating current frequency is within a range of frequencies outside those of normal supply frequencies,
a switch switching the motor into programming mode in response to the activation of the detector mode,
a second detector mode activated by switching the motor into programming mode and detecting changes in the alternating current supply frequency as programming data.

2. A programmable alternating current supplied motor as claimed in claim 1 wherein the first detector mode is activated by a frequency substantially below the normal supply frequency.

3. A programmable alternating current supplied motor as claimed in claim 2 wherein the first detector mode is activated by a frequency of substantially 36 Hz.

4. A programmable alternating current supplied motor as claimed in claim 1 wherein the second detector mode is activated by variations in frequency substantially above the normal supply frequencies.

5. A programmable alternating current supplied motor as claimed in claim 4 wherein the second detector mode is activated by frequencies varying between 160 Hz and 210 Hz centred around 190 Hz.

6. A method of programming an AC supplied electronically commutated motor having a programmable motor controller by detecting at the motor the frequency of the supplied motor power, detecting in a first detection mode when the frequency of the supplied motor power indicates the initialization of a programming sequence in the supplied motor power, switching the motor controller into a second detection programming mode on detection of that frequency, receiving subsequent variations in frequency of the supplied motor power as motor controller programming instructions, and programming the instructions to the motor controller on successful receipt of the programming sequence.

7. A method of programming an AC supplied electronically commutated motor as claimed in claim 6 wherein the frequency indicating initialization is substantially below the design operating frequency of the motor.

8. A method of programming an AC supplied electronically commutated motor as claimed in claim 6 wherein the subsequent variations in frequency are substantially above the design operating frequency of the motor.

9. A method of programming an AC supplied electronically commutated motor as claimed in claim 6 wherein the subsequent variations in frequency vary between two frequencies.

10. A method of programming an AC supplied electronically commutated motor as claimed in claim 6 wherein the subsequent variations in frequency vary between three frequencies.
